(19) United States
(12) Patent Application Publication
(10) Pub. No.: US 2006/0285708 A1
(43) Pub. Date: Dec. 21, 2006

(54) Hearing aid apparatus and method of using same

(76) Inventor: James D. Guinn, Tulsa, OK (US)

Correspondence Address: Frank L. Hart;Attorney at Law, 8911 S. 73rd East Ave., Tulsa, OK, 74133, US

(21) Appl. No.: 11/143,135

(22) Filed: Jun. 3, 2005

(51) Int. Cl. H04R 25/00

(52) U.S. Cl. 381/312

(57) ABSTRACT

Apparatus and method for providing an electromagnetic audio signal of increased volume perception from an apparatus to an individual wearing a hearing aid having a telephone switch at the “On” position while maintaining the audio volume of speakers of the apparatus at a lower magnitude.

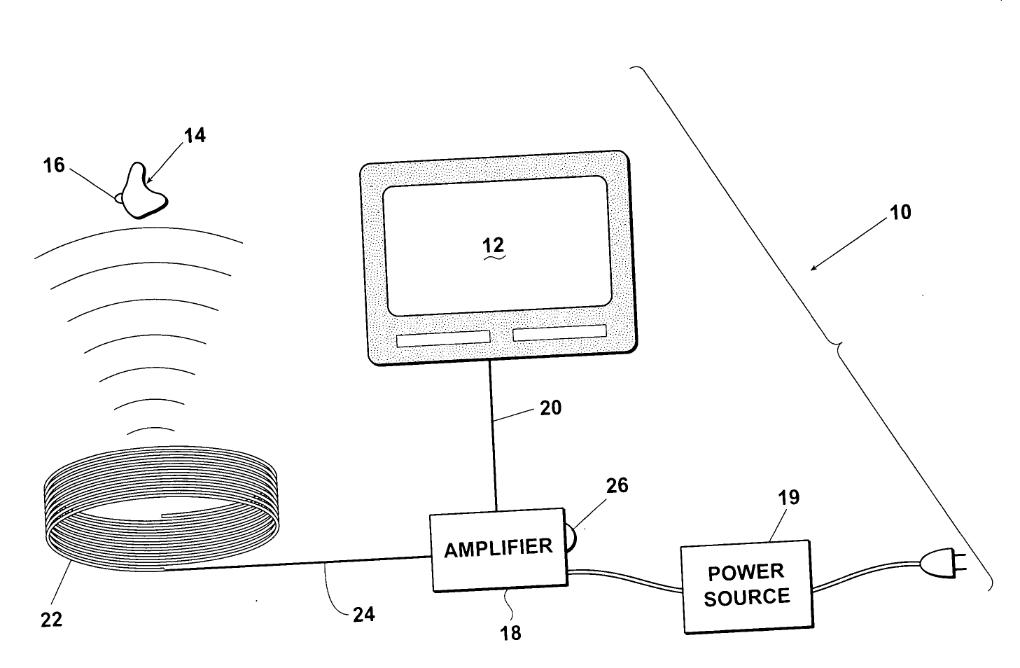

### BACKGROUND OF THE INVENTION

1. Field of the Invention

The subject invention relates to an apparatus for use with a personal hearing aid. More particularly, the subject invention relates to apparatus and method for increasing the volume perception of an electromagnetic signal from a television signal, for example, to an individual wearing a hearing aid having a telephone switch at the “On” position while maintaining the audio volume of the television, for example, at a low magnitude.

2. Description of Related Art Including Information Disclosed Under 37 CFR 1.97 and 1.98

One of the problems associated with the hearing impaired is providing a audio signal of sufficient increased volume perception that the user of a hearing aid can comfortably hear and understand the output while maintaining the output at a lower magnitude. Such output would be the electromagnetic waves generated by a television, computer, or radio, for example.

In many cases, for an individual having a hearing aid to listen to a television program, for example, he must have the volume of the hearing aid turned to the highest possible setting and the output from the television speaker at such a high setting it would be uncomfortable to other people in the area. This is particularly true in apartment complexes where sometimes thin walls separate the individual families.

The present invention is directed to overcome one or more of the problems, as set forth above.

### BRIEF SUMMARY OF THE INVENTION

In one aspect of the invention, a kit is provided for use with a personal hearing aid which has a telephone switch at its “On” position. An amplifier is connectable to a signal and a wire coil is connected to the amplifier. The wire coil is positioned adjacent the hearing aid.

In another aspect of the invention, a method is provided for use with an apparatus delivering audio signals and for providing an electromagnetic audio signal of increased volume to an individual wearing a hearing aid having a telephone switch at the “On” position while maintaining the audio volume of speakers of said apparatus at a lower magnitude. The kit, as set forth in claim 1 is provided and an electromagnetic audio signal is delivered from said apparatus to the amplifier. An amplified signal from the amplifier is delivered to the wire coil and a signal from the wire coil is delivered through the air to the hearing aid.

### BRIEF DESCRIPTION OF THE SEVERAL VIEWS OF THE DRAWING(S)

The single FIGURE of the drawing is a diagrammatic view of the apparatus of this invention associated with an electromagnetic audio signal and a personal hearing aid.

### DETAILED DESCRIPTION OF THE INVENTION

Referring to the drawing, a kit or apparatus 10 of this invention is shown associated with an apparatus 12 delivering an electromagnetic signal, such as a television, radio, computer or radio, for example and with a personal hearing aid 14. The hearing aid 14 has a telephone switch 16 associated with an induction coil (not shown) as is known in the art.

The kit 10 includes an amplifier 18, having a power source 19 and is connectable to a television signal. Preferably the power source includes a transformer connected to house current. Also preferably, the amplifier 18 is connected via line 20 so that the amplifier and associated equipment of this invention can be in close proximity to the user which will generally be spaced several feet from the apparatus emitting the electromagnetic signal. A wire coil 22 is connected to the amplifier 18. The wire coil 22 is preferably connected to the amplifier 18 by a line 24 so that the coil 22 can be positioned at a convenient location relative to and remote from the hearing aid 14 worn by a user.

In the preferred embodiment of this invention, the amplifier 18 has a controller 26 for adjusting the magnitude of the output of the amplifier 18 and is of sufficiently small size to be considered a “hand held” amplifier. The amplifier 18 has a power source 19, preferably a transformer connectable to house power.

The preferred embodiment also has a plurality of coils, more particularly coils in number in the range of about 8 to about 33 having a coil diameter in the range of about 10 to about 40 inches.

Increased volume perception is provided to an individual wearing a hearing aid having a telephone switch at the “On position while maintaining the audio volume of speakers at a lower and more comfortable magnitude for the listening pleasure of other individuals in the vicinity.

In the use of this invention, the kit 10, as described above, is provided. An electromagnetic audio signal is delivered from an apparatus, such as a television for example, to the amplifier 18. An amplified signal is delivered from the amplifier 18 to the wire coil 22. A signal from the wire coil 22 is delivered through the air to the remote hearing aid 14.

In the preferred method of use, the output volume of the amplifier 18 is controllable and the method of use includes adjusting the output volume of the amplifier 18 to a desired level by the user.

1. A kit for use by an individual with a personal hearing aid having a telephone switch at its “On” position and a apparatus for delivering electromagnetic audio signals, comprising:
an amplifier having a power source and being connectable to the audio apparatus; and
a wire coil connected to the amplifier, said wire coil being positioned spaced from and adjacent said hearing aid.

2. A kit, as set forth in claim 1, wherein the amplification of the amplifier is controllable.

3. A kit, as set forth in claim 1, wherein the wire coil has a plurality of coils.

4. A kit, as set forth in claim 1, wherein the wire coil has a diameter in the range of about 10 inches to about 40 inches.

5. A method for use with an apparatus delivering audio signals and for providing an electromagnetic audio signal of increased volume to an individual wearing a hearing aid having a telephone switch at the “On” position while maintaining the audio volume of speakers of said apparatus at a lower magnitude, comprising:
providing the kit, as set forth in claim 1;
delivering an audio signal from the television to the amplifier;
delivering an amplified signal from the amplifier to the wire coil; and
delivering a signal from the wire coil, through the air to the remote haring aid.

6. A method, as set forth in claim 5, including adjusting the volume output of the amplifier.
